(19) United States
(12) Patent Application Publication
(10) Pub. No.: US 2024/0394079 A1
(43) Pub. Date: Nov. 28, 2024

(54) SYSTEMS AND METHODS FOR GENERATIVE GUIDANCE FOR TASKS

(71) Applicant: Kinaxis Inc., Ottawa (CA)

(72) Inventors: David Christopher DEWAR, Ottawa (CA); Nancy XU, Ottawa (CA); Christopher BURT, Ottawa (CA)

(21) Appl. No.: 18/670,857

(22) Filed: May 22, 2024

Related U.S. Application Data
(60) Provisional application No. 63/503,775, filed on May 23, 2023.
(60) Provisional application No. 63/503,799, filed on May 23, 2023.

(51) Int. Cl. G06F 9/451

(52) U.S. Cl. CPC G06F 9/453

(57) ABSTRACT

Systems and methods are provided for generative guidance for tasks. The systems and methods disclosed herein speed up the learning time for new users and the creation time for advanced users, by providing the most likely next steps visible to a user, and actionable with a single gesture. The systems and methods disclosed herein augment the user by providing an easy-to-use set of contextual actions as the user works to create solutions. When creating a resource, there is a selection context, such as a selected element. The system and methods present, to the user, likely next steps close to the selected element, that are directly available.

This application claims priority from: U.S. Ser. No. 63/503,775 filed May 23, 2023; and U.S. Ser. No. 63/503,799 filed May 23, 2023, the disclosure of each of which is hereby incorporated by reference in its respective entirety.

### BACKGROUND

It is difficult to learn how to create solutions such as workbooks, dashboards and forms since knowledge is required about the platform/systems that these solution resources are based on. It can take many months for a new user to develop the skills needed. In addition, even advanced users can be slow to create such solutions.

### BRIEF SUMMARY

The systems and methods disclosed herein speed up the learning time for new users and the creation time for advanced users, by providing the most likely next steps visible to a user, and actionable with a single gesture.

The systems and methods disclosed herein augment the user by providing an easy-to-use set of contextual actions as the user works to create solutions. When creating a resource, there is a selection context, such as a selected element. The system and methods present, to the user, likely next steps close to the selected element, that are directly available.

As an example, when a user creates a workbook, the next likely step is to create a worksheet. With a worksheet, the next likely steps are to create columns. As a result, the systems and methods disclosed herein can either present these next steps as actions while the user is in an authoring flow or they can automate the creation of elements for the user. This system augments the user by providing an easy-to-use set of contextual actions as the user works to build a resource.

In one aspect, a system is provided; the system includes a processor. The system also includes a memory storing instructions that, when executed by the processor, configure the system to: select, by the processor, a resource based on a user selection of the resource on a graphical user interface; set, by the processor, a context of the resource; change, by the processor, the context to a new context, based on user interaction with the a graphical user interface; notify, by the processor, one or more listeners of a context change; notify, by the processor, an action planner of the context change; process, by the processor, the new context; compute, by the processor, one or more successive steps for the new context; prioritize, by the processor, the one or more successive steps for the new context; return, by the processor, a prioritized set of action commands; broadcast, by the processor, the prioritized set of action commands to the one or more listeners; and render, by the processor, the prioritized set of action commands to the user for selection.

The system may also include further instructions that configure the system to execute, by the processor, one or more action commands selected by the user. In the system, the resource may be at least one of a workbook, a dashboard and a form. In the system, the graphical user interface can include a canvas; the canvas can include at least one of a visual modeler, a resource properties panel and a resource preview panel. When there is only one successive step, the instructions can further configure the system to automatically execute, by the processor, the one successive step. When computing the one or more successive steps for the new context, the instructions can further configure the system to: load, by the processor, one or more specifications of the resource; and use, by the processor, one or more pre-defined rules for computing the one more successive steps. Alternatively, when computing the one or more successive steps for the new context, the instructions can further configure the system to execute, by the processor, a machine learning model. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: select, by the processor, a resource based on a user selection of the resource on a graphical user interface; set, by the processor, a context of the resource; change, by the processor, the context to a new context, based on user interaction with the a graphical user interface; notify, by the processor, one or more listeners of a context change; notify, by the processor, an action planner of the context change; process, by the processor, the new context; compute, by the processor, one or more successive steps for the new context; prioritize, by the processor, the one or more successive steps for the new context; return, by the processor, a prioritized set of action commands; broadcast, by the processor, the prioritized set of action commands to the one or more listeners; and render, by the processor, the prioritized set of action commands to the user for selection.

The non-transitory computer-readable storage medium may also include further instructions that configure the computer to execute, by the processor, one or more action commands selected by the user. In the non-transitory computer-readable storage medium, the resource can be at least one of a workbook, a dashboard and a form. In the non-transitory computer-readable storage medium, the graphical user interface can also include a canvas; the canvas can include at least one of a visual modeler, a resource properties panel and a resource preview panel. When there is only one successive step, the instructions can further configure the computer to automatically execute, by the processor, the one successive step. When computing the one or more successive steps for the new context, the instructions can further configure the computer to: load, by the processor, one or more specifications of the resource; and use, by the processor, one or more pre-defined rules for computing the one more successive steps. Alternatively, when computing the one or more successive steps for the new context, the instructions can further configure the computer to execute, by the processor, a machine learning model. Other technical features may be readily apparent to one skilled in the art from the following figures, descriptions, and claims.

In one aspect, a computer-implemented method is provided, that includes: selecting, by a processor, a resource based on a user selection of the resource on a graphical user interface; setting, by the processor, a context of the resource; changing, by the processor, the context to a new context, based on user interaction with the graphical user interface; notifying, by the processor, one or more listeners of a context change; notifying, by the processor, an action planner of the context change; processing, by the processor, the new context; computing, by the processor, one or more successive steps for the new context; prioritizing, by the processor, the one or more successive steps for the new context; returning, by the processor, a prioritized set of action commands; broadcasting, by the processor, the prioritized set of action commands to the one or more listeners; and rendering, by the processor, the prioritized set of action commands to the user for selection.

The computer-implemented method may also include: executing, by the processor, one or more action commands selected by the user. In the computer-implemented method, the resource can be at least one of a workbook, a dashboard and a form. In the computer-implemented method, the graphical user interface can include a canvas; the canvas can include at least one of a visual modeler, a resource properties panel and a resource preview panel. When there is only one successive step, the method can further include automatically executing, by the processor, the one successive step. When computing the one or more successive steps for the new context, the method may further include: loading by the processor, one or more specifications of the resource; and using, by the processor, one or more pre-defined rules for computing the one more successive steps. Alternatively, when computing the one or more successive steps for the new context, the method can include: executing, by the processor, a machine learning model. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for generative guidance for tasks in accordance with one embodiment.

FIG. 2 illustrates a set of resource creation actions in accordance with one embodiment.

FIG. 3 illustrates a block diagram in accordance with one embodiment.

FIG. 4A illustrates creation of a resource in accordance with one embodiment.

FIG. 4B illustrates a graphical user interface in relation to FIG. 4A.

FIG. 4C illustrates the graphical user interface in relation to FIG. 4B.

FIG. 4D illustrates the graphical user interface in relation to FIG. 4C.

FIG. 5 illustrates creation of a resource in accordance with one embodiment.

FIG. 6A illustrates generation of elements in accordance with one embodiment.

FIG. 6B illustrates generation of elements in accordance with one embodiment.

FIG. 7A illustrates creation of a resource in accordance with one embodiment.

FIG. 7B illustrates a graphical user interface in relation to FIG. 7A.

FIG. 7C illustrates a graphical user interface in relation to FIG. 7B.

FIG. 7D illustrates a graphical user interface in relation to FIG. 7C.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, system, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing system memory devices, or any suitable combination of the foregoing, but would not include propagating signals. In the context of this document, a computer readable storage medium may be any tangible medium that can contain, or store a program for use by or in connection with an instruction execution system, system, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, systemes, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing system to produce a machine, such that the instructions, which execute via the processor of the computer or other programmable data processing system, create means for implementing the functions/acts specified in the schematic flowchart diagrams and/or schematic block diagrams block or blocks.

These computer program instructions may also be stored in a computer readable storage medium that can direct a computer, other programmable data processing system, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing system, or other devices to cause a series of operational steps to be performed on the computer, other programmable system or other devices to produce a computer implemented process such that the instructions which execute on the computer or other programmable system provide processes for implementing the functions/acts specified in the flowchart and/or block diagram block or blocks.

The schematic flowchart diagrams and/or schematic block diagrams in the Figures illustrate the architecture, functionality, and operation of possible implementations of systems, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and system can also be implemented as, special purpose logic circuitry, e.g., an FPGA (field programmable gate array) or an ASIC (application specific integrated circuit). For example, the processes and logic flows that can be performed by an system, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The system can include clients and servers. A client and server are generally remote from each other and typically interact through a communication network. The relationship of client and server arises by virtue of computer programs running on the respective computers and having a client-server relationship to each other.

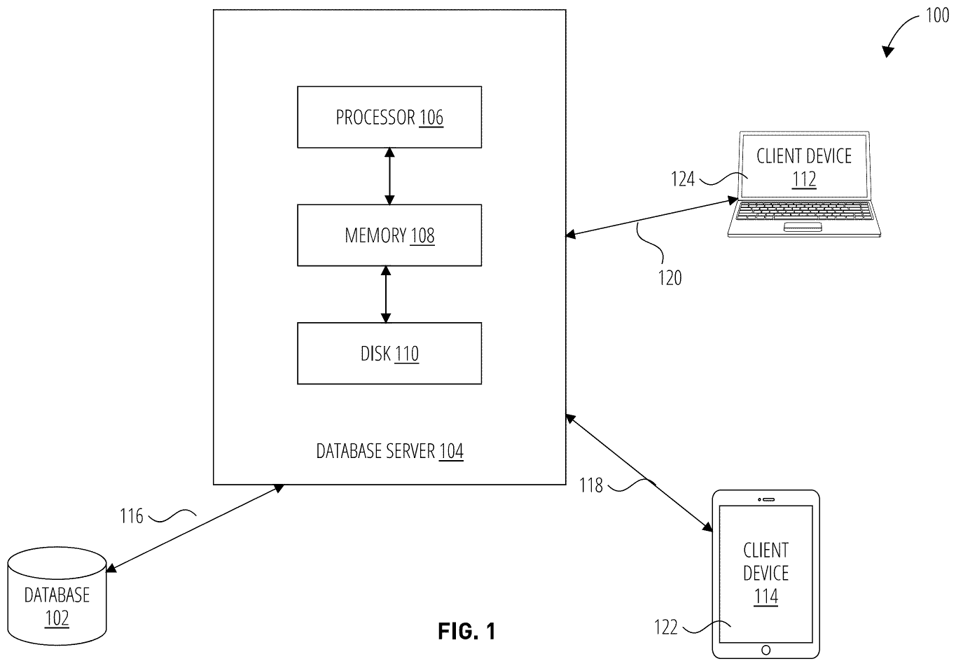

FIG. 1 illustrates an example of a system 100 for generative guidance for tasks.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

The systems and methods disclosed herein can comprise the following:
1) Resource Specification, which is a definition of possible elements and syntax rules.
2) Selected Element(s) that defines a user's current context in resource creation.
3) An Action Planner, which is a system that can understand the resource specification, knows the user's creation context (from selected elements) and can subsequently execute an algorithm to determine useful next actions
4) An Action Planner Algorithm, which is an algorithm that can produce a likely set of next steps to be presented to a user, based on the current context and the type of resource they are creating. There are different approaches that can be used, such as: a rules-based system, goal-oriented action planning, an Artificial Intelligence model, and the like. The systems and methods disclosed herein can work with different types of action planning.
5) An Action Renderer, which presents the choice of possible actions in context to an end user at a point where they are currently focused on working.
6) An Action Command, which can facilitate execution of the selected user action.

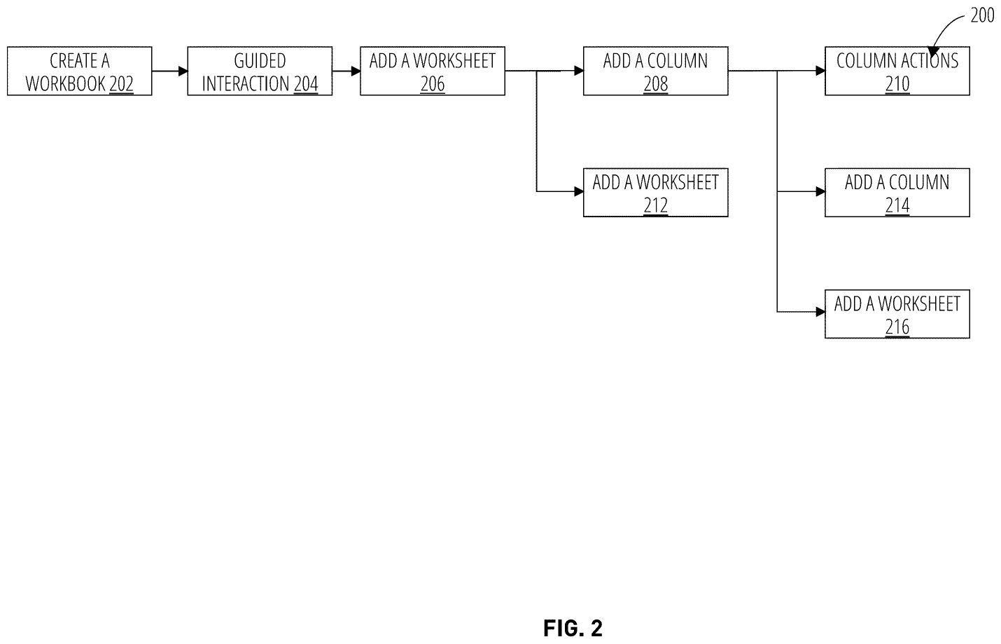

FIG. 2 illustrates a set of resource creation actions 200 in accordance with one embodiment. In the embodiment shown in FIG. 2, the resource is a workbook. At block 202, a user creates a workbook. Next, guided interaction 204 begins, which offers next steps. This includes a first sequence in which it is suggested to the user to add a worksheet (block 206). Thereafter, the guided interaction then suggests a next sequence: addition of a column (block 208) and/or addition of a worksheet (block 212). After this sequence, the guided interaction then suggests at least one of the following steps to the user: column actions (block 210), adding another column (block 214) and adding a worksheet (block 216).

In FIG. 2, the Guided Interaction 204 is available at each subsequent step, explained as follows. In FIG. 2, the system can provide suggested next actions based on the context of the content a user is are creating. When the user chooses an action, the system can compute new next actions. This way a user can be guided step-by-step through a complicated set of actions. Every step can be marked by a user action, followed by a system response which offers to guide the user to a series of next steps.

As an example, illustrated in FIG. 2, after a worksheet is added at block 206, the system offers the option to add a column (block 208) or a new worksheet (block 212). Other actions, not shown in FIG. 2, are also possible. When a user chooses to add a worksheet at block 212, the user is offered the same choices as in block 206. After the new worksheet is created, that new worksheet becomes the focus; the user can then add a column to it (at block 208) or create a new worksheet once again (at block 212). These are a few examples of guided actions; other guided actions are possible. In summary, for any given state of the application, the system can offer choices of action to a user. For each step the user takes, the user's focus in the application changes. Previous choices are removed and new actions are provided.

A number of the elements shown in FIG. 2, are described below in further detail.

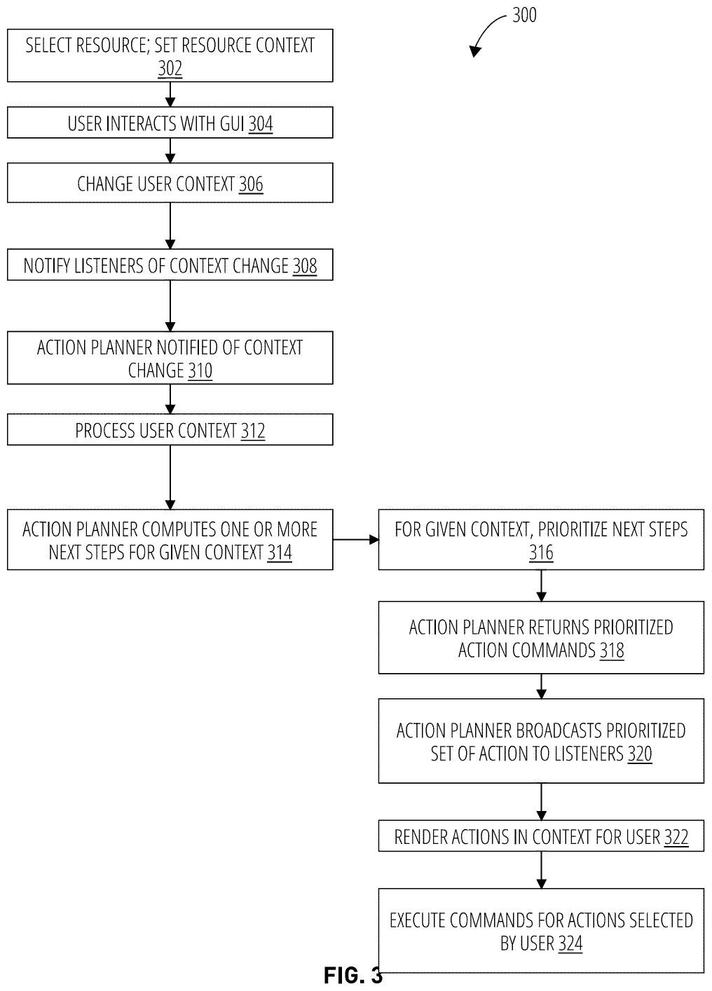

FIG. 3 illustrates a block diagram 300 in accordance with one embodiment.

At block 302, a user selects a resource via a Graphical user interface (GUI), at which point, a context of the resource is established. When the user further interacts with the GUI at block 304, the user context is changed at block 306. This interaction can include, for example, selection of one or more suggested steps. One or more listeners are notified of the user context change at block 308. As an example of a context change, the user can select a new element. An action planner is then notified of the change at block 310, and then begins processing the user context at block 312.

The Action Planner then computes one or more next steps for the given context at block 314. For example, resource specifications can be loaded, and next steps can be computed based on predefined rules. In an embodiment, machine learning can be used to compute all possible next steps. In yet another embodiment, reference can be made to a machine learning model that is created from recordings of previous users or experts; such a trained model can be used to predict next steps.

The set of next steps is then prioritized for the given context at block 316. The Action Planner then returns a prioritized set of action commands at block 318 for the given context. The Action Planner then broadcasts the prioritized set of actions to the one or more listeners at block 320. These actions in context are then rendered for the user to choose from, at block 322. That is, the user is presented with prioritized action in context. Commands are then executed for the user-selected actions at block 324.

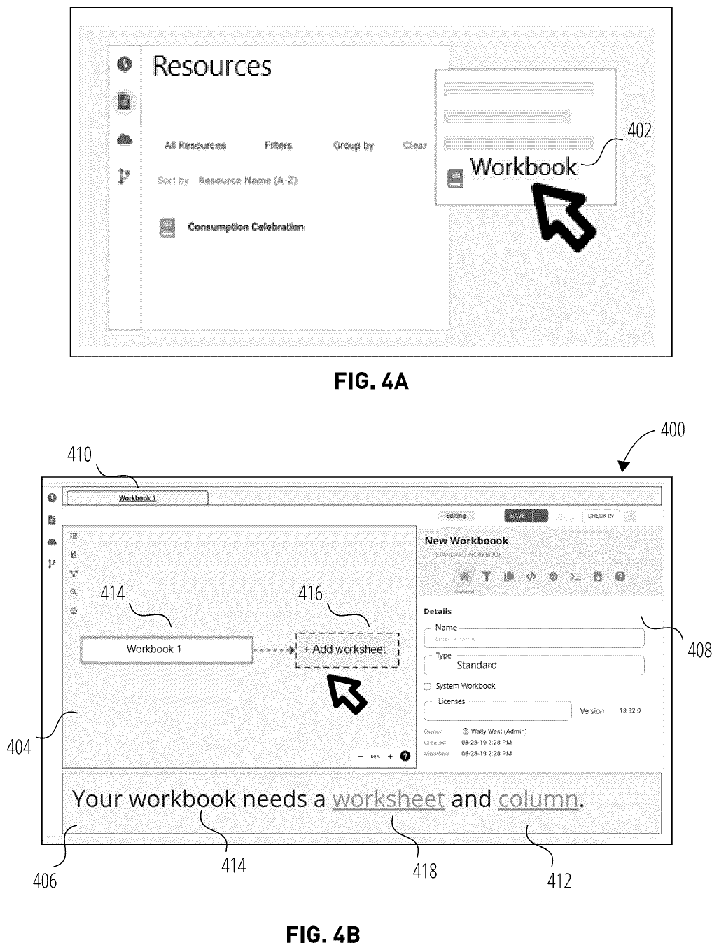

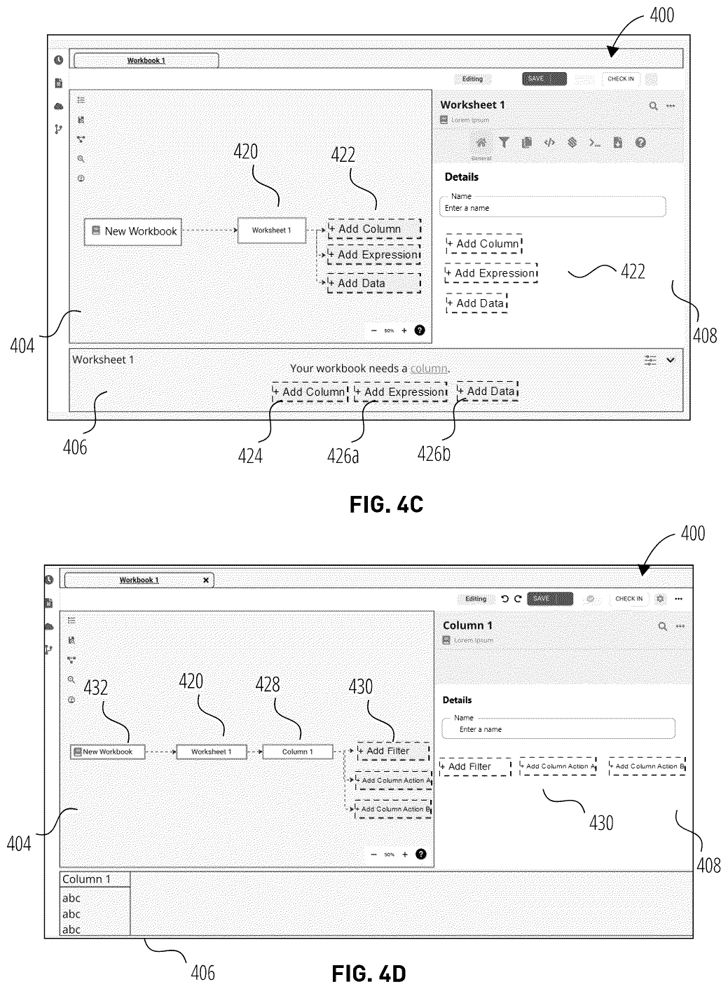

FIG. 4A illustrates creation of a resource in accordance with one embodiment. Here, as in block 202 of the embodiment shown in FIG. 2, a user creates a resource, namely a workbook 402. Other choices of a resource are also possible, such as a dashboard, a form, and the like.

FIG. 4B illustrates a graphical user interface 400 in relation to FIG. 4A. In this embodiment, a user is provided with a canvas with three distinct viewing areas: area 404, area 406 and area 408. Other arrangements and numbers of viewing areas are possible.

In FIG. 4B, area 404 can provide a visual model of the resource, which in this embodiment, is a workbook 410, which is the resource that had been selected in FIG. 4A. Area 406 is a preview of the selected resource (that is, workbook 410). However, no preview of the workbook 410 is possible until a worksheet 418 and column 412 are created, as shown by the prompt in area 406. Thus, the user is told, or guided, that the next steps towards preparing a workbook include creation of a worksheet (418) and a column (412). Furthermore, area 404 also provides a prompt (for adding a worksheet) for the next step in preparation of the workbook 410. Thus, suggestions for the next steps in preparing a workbook 410 can be provided in more than one area on the canvas. Area 408, a properties panel, can provide the user input fields for the new workbook, along with information about one or more properties of the resource.

In the visual model shown in area 404, context-sensitive actions can appear to the user, based on the context of the previously-selected action. For example, in FIG. 4B, the previously-selected action (in FIG. 4A) is the creation of a workbook. Thus, the context 414 is a workbook. The suggested action(s) will be related to this context, which in this instance, is the addition of a worksheet (action 416). That is, a workbook has been selected, and the suggested action 416 is addition of a worksheet.

Similarly, in the preview area 406, context-sensitive actions are provided. As in area 404, the context 414 is the previously-selected action, which in FIG. 4B, is a workbook. The context-sensitive actions include creation of a worksheet (action at 418) and columns (action at 412).

In area 408, properties can also have context-sensitive actions, although none are shown in FIG. 4B.

FIG. 4C illustrates the graphical user interface 400 in relation to FIG. 4B, after the user has selected the action to add a worksheet (item 418 in FIG. 4B).

As in FIG. 4B, there are three areas on the canvas: area 404 (where a visual model of the workbook, while it is being created, is illustrated), area 406 (a preview of the workbook), and area 408 (where properties of the workbook are illustrated).

In area 404, the context has now changed from that of FIG. 4B. Namely, the context 420 is now a worksheet, and context-sensitive actions are computed, and appear as actions 422. For the context of a worksheet, three possible actions are shown: adding a column, adding an expression, and adding data. Other actions, namely, those that support building a worksheet, are possible for this context.

In the preview area 406, the workbook still cannot be previewed, since one more action is required: namely: inserting a column, which is prompted at 424. The other suggested actions, which can be optional, include adding an expression (action 426a) and adding data (action 426b). Other actions, namely, those that support building a worksheet, are also possible for this context.

The property panel (area 408) can also illustrate the context-sensitive actions 422.

FIG. 4D illustrates the graphical user interface in relation to FIG. 4C, after the user has selected the action to add a column and add data (in text form) to the column that has been added.

As in FIG. 4C, there are three areas on the canvas: area 404 (where a visual model of the workbook, as it is created, is illustrated), area 406 (a preview of the workbook), and area 408 (where properties of the workbook are illustrated).

In area 404, the context has now changed from that of FIG. 4C. Namely, the context 428 is now a column, and context-sensitive actions are computed, and appear as actions 430. For the context of a column, three possible actions are shown: adding a filter, adding column action A, and adding column action B. Other actions, that support building a column, are also possible for this context.

In the preview area 406, the workbook can now be previewed, since the basic elements for building a workbook have been created. Due to the actions selected from the prompts given in FIG. 4C (namely, addition of a column and addition of data), the workbook has a column (Column 1), with the data shown. Thus, as the user edits the workbook using the visual model (area 404), the workbook runs and is displayed in the preview (area 406) to show the user what they have created.

The property panel (area 408) can also illustrate the context-sensitive actions 430.

If the user wishes to add one or more columns (in addition to Column 1) to Worksheet 1, then the user will select “Worksheet 1” (420), at which point, the worksheet will become the context (see FIG. 4C). At this point, the user can then select the action “add column”, and a new column will be added to Worksheet 1. The graphical user interface 400 will then show prompts for the new column as in FIG. 4D, all the while showing the full worksheet, with two columns, in the preview area 406. Similarly, if the user wants to add a new worksheet, then the user will select “New Workbook” 432 as the context, and the graphical user interface 400 will provide a visual model area 404 similar to that of FIG. 4B, at which point the user will select the prompted action “Add Worksheet” (action 416 in FIG. 4B). Thus, any number of worksheets and column can be added to build the workbook. The preview area 406 can then accommodate a tab for each corresponding worksheet, and preview the contents of each worksheet separately.

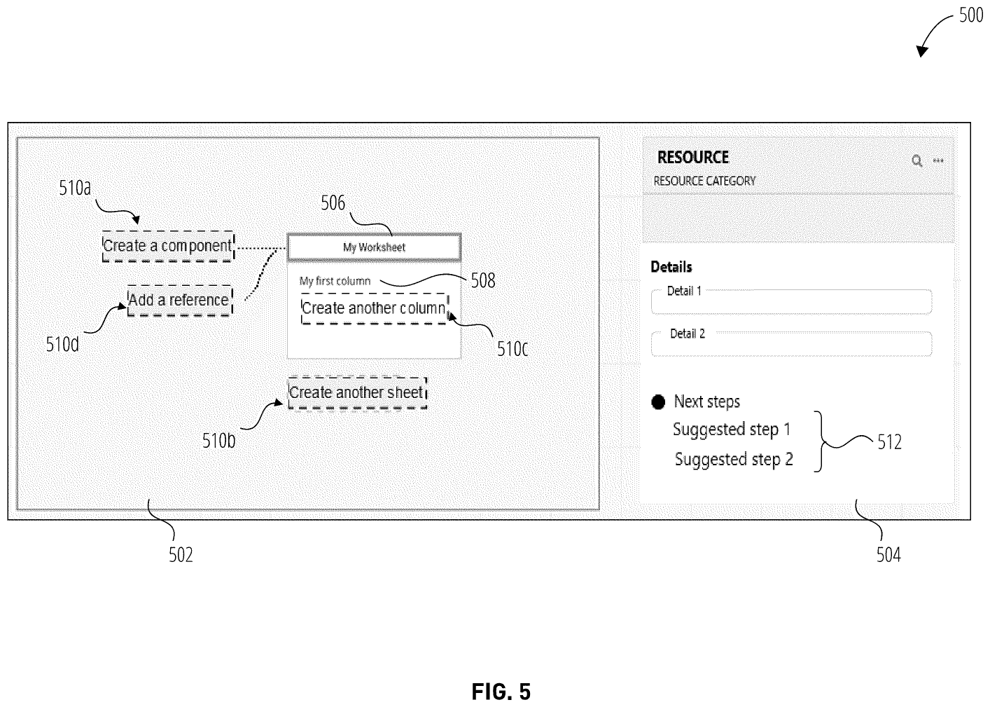

FIG. 5 illustrates creation of a resource in accordance with one embodiment, as shown on graphical user interface 500.

In the embodiment shown in FIG. 5, a canvas includes a first area which is a visual modeler 502 and a second area, which is a properties panel 504. There can be a third area, such as a preview panel (similar to what is shown as areas 406 in FIG. 4B-FIG. 4D). In the visual modeler 502, where there is only one suggested action for a context, the action is actually carried out, while multiple suggested actions (or guidance elements 510a-510d) for a context, are automatically displayed to the user. In the embodiment shown in FIG. 5, guidance element 510a refers to creation of a component; 510b refers to creation of another worksheet; 510c refers to creation of another column; and 510d refers to addition of a reference.

In the embodiment shown in FIG. 5, the resource is a workbook. The only suggested action for a workbook is addition of a worksheet, while the only suggested action for a worksheet is the addition of a column (see, for example, preview area 406 in FIG. 4B). Here, in FIG. 5, these actions are automatically carried out, as shown in visual modeler 502—namely, the automatic creation of a worksheet 506 and a column 508.

In the embodiment shown in FIG. 5, the suggested actions are provided to the user automatically and these actions are one click away. Prior to the methods and systems disclosed herein, users take a long time to learn how to use a product that requires a series of steps. Here, the visual modeler 502 displays what the next likely steps are and also makes it really quick to select a step. This is designed to allow users to learn faster and act faster, by being guided.

In summary, FIG. 5 illustrates guidance elements 510a-510d available to a user as shown in visual modeler 502. In the embodiment shown in FIG. 5, guidance element 510a refers to creation of a component; 510b refers to creation of another worksheet; 510c refers to creation of another column; and 510d refers to addition of a reference. These can also be displayed as “next steps” components 512 for properties in properties panel 504. The visual suggestions can also be displayed in a preview panel (not shown). In this embodiment, while one or more steps can be automated, the user is still presented with guided choices for next steps.

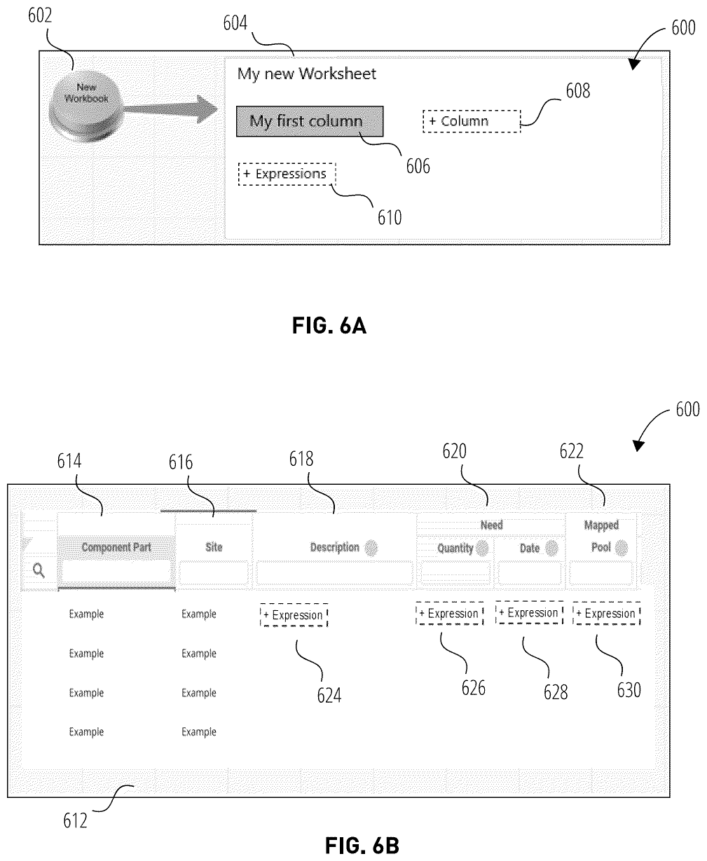

FIG. 6A illustrates generation of elements in accordance with one embodiment, as shown in the graphical user interface 600.

In general, elements that are not optional for the buildup of a resource, can be automatically generated for the user. The user can be given choices for optional elements alone. In the embodiment shown in FIG. 6A, the resource is a workbook 602.

Once a new workbook 602 is selected, in this embodiment, the system ascertains that the two subsequent steps are not optional. That is, the system determines that the next required steps are addition of a worksheet and a column, respectively. As such, a new worksheet 604 is automatically added, followed by a first column 606. No user intervention is required up to this point, since the system knows how to build the resource. This is in contrast to FIG. 4A-FIG. 4C, in which the user is asked to select creation of a worksheet, and then asked to select creation of a column.

In the embodiment shown in FIG. 6A, once the workbook 602 is selected, the system automatically generates a worksheet 604 and a column 606, such that the user only needs to select one step amongst a number of optional steps: adding another column at 608, or adding one or more expressions at 610. Other optional steps are possible. For each type of resource, there can be a different number of non-optional steps, and thus a different number of automatically generated contexts. Similarly, there can be a different number of optional steps for each context.

FIG. 6B illustrates generation of elements in accordance with one embodiment, as shown in the graphical user interface 600.

In the embodiment shown in FIG. 6B, a preview 612 of a workbook is shown. The first two columns 614 and 616 are already pre-defined in this example, and thus, the entries are already populated therein. However, for columns 618 (Description), 620 (Need-with sub-columns Quantity and Date) and 622 (Mapped), the user is guided to input an expression 624, expression 626, expression 628 or expression 630 in any one of those columns. Thus, a user is offered guidance at various places as to what the next steps are, for continuing to build the resource. This makes it easy for the user to build the resource, since the user does not have to guess, or look up in a manual, as to what the next possible steps are. Furthermore, these next steps are displayed clearly, and can be activated by a single click, thus making it easy for the user to activate the selected step.

FIG. 6A and 6B are independent of each other, yet illustrate the generation of elements. As in FIG. 2, the system responds to each action the user takes. With reference to FIG. 6A, if the user creates a worksheet 604, two options for the column 606: create a new column (item 608), or, define an expression (item 610) for column 606. As an example, if column 606 is a margin calculation, the expression can be defined as Price—Cost or Revenue—Expenses.

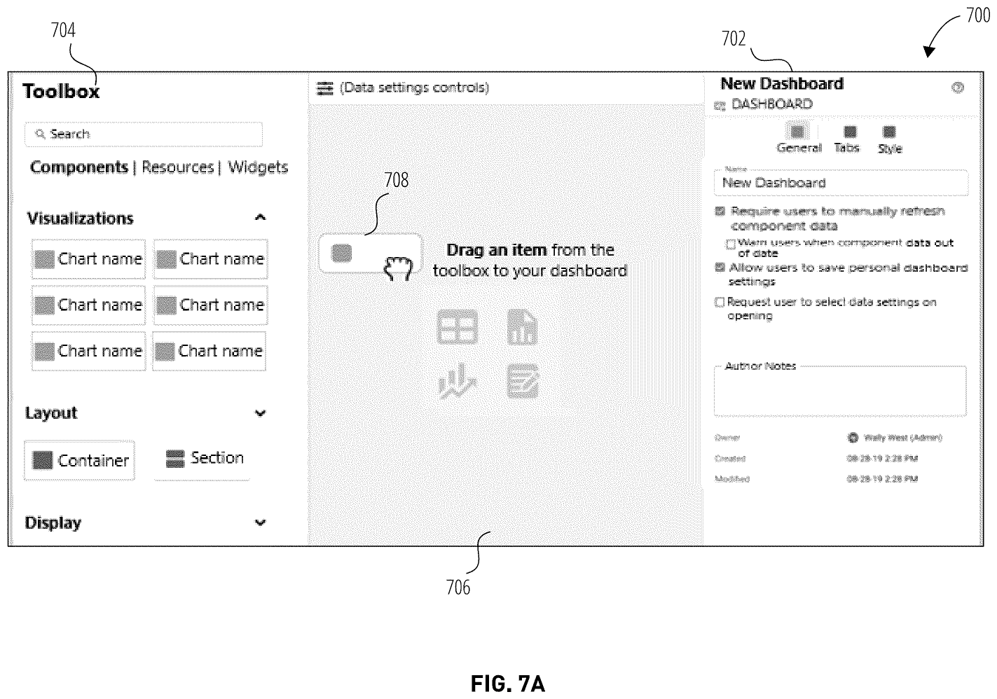

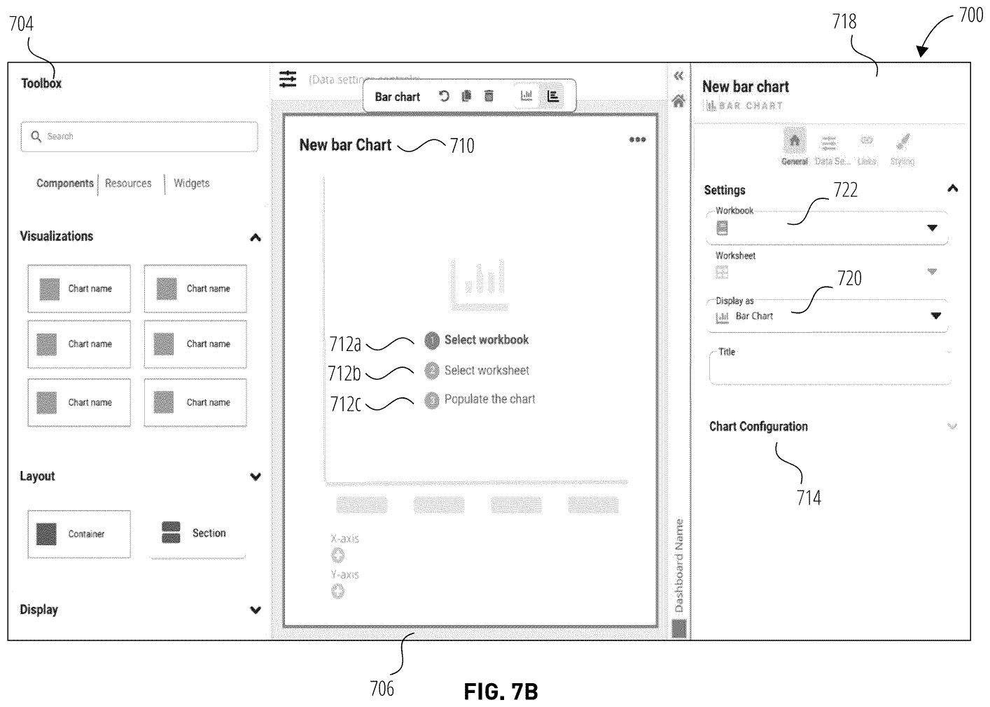

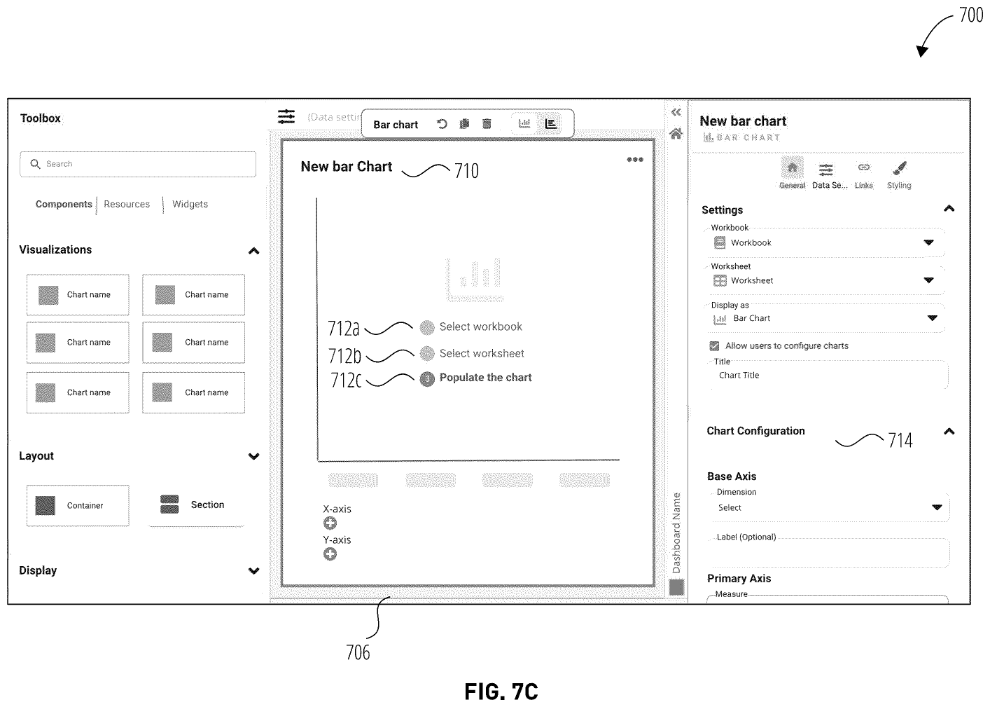

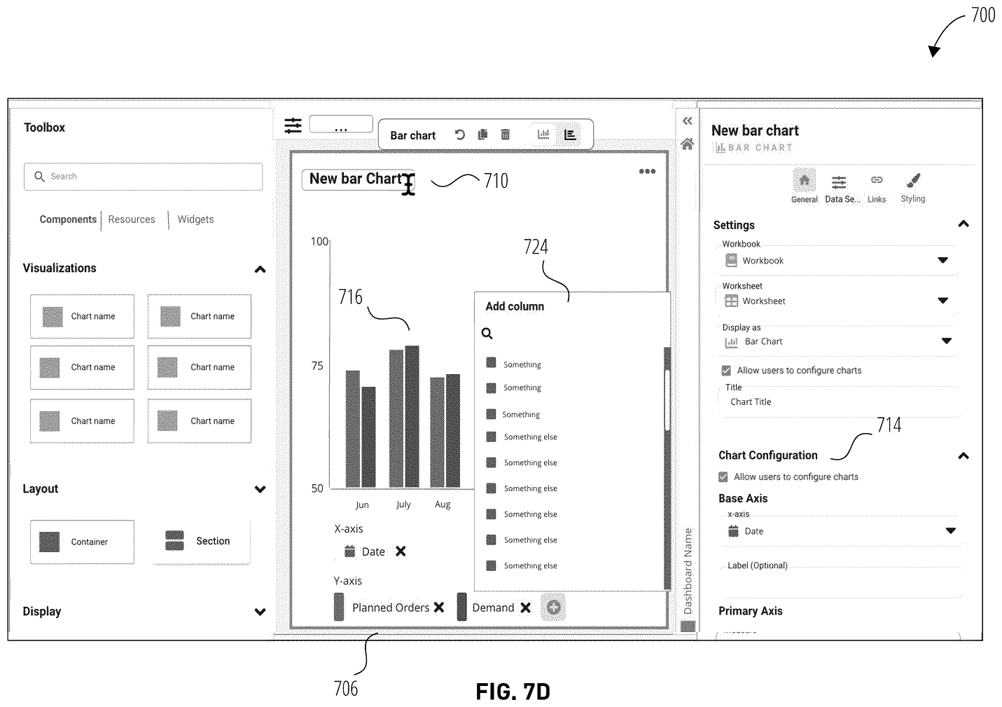

FIG. 7A illustrates creation of a resource in accordance with one embodiment, as shown in the graphical user interface 700. In FIG. 7A, the resource that is under creation is a dashboard 702. The graphical user interface 700 provides a toolbox 704 and a dashboard canvas 706, in which a user drags an element 708 from the toolbox 704 onto the dashboard canvas 706. In FIG. 7A, the element 708 selected is a new chart (to place on dashboard 702). Selection of element 708, results in a series of prompts to guide the user on how to further build a chart on the dashboard, so that the user does not have to search to find out what the next set of steps are. These prompts are illustrated in FIG. 7B-FIG. 7D.

FIG. 7B illustrates a graphical user interface 700 in relation to FIG. 7A.

Once the user has dragged a new chart (element 708 in FIG. 7A) onto the dashboard canvas 706 (in FIG. 7A), the system can provide a set of prompts shown in dashboard canvas 706 in FIG. 7B, in order to build a new chart 710. Not only is guidance provided to the user, but the guidance is also active, in that the user can select a prompted next step, and there will be an execution based on the selected step, followed by another prompt for the next step.

In FIG. 7B, chart properties 718 are now visible to the user, along with the prompts 712a-712c for the user that outline a sequence of steps for preparation of chart 710. In terms of chart properties 718, the user selects a chart type 720 (in this embodiment, the chart type 720 selected is a bar chart). The sequence of prompts indicates to the user that: first, a workbook is selected at step 712a, followed by selection of a worksheet at step 712b, followed by population of the chart at 712c. That is, the system walks the user through a series of steps for generation of a chart 710 on a dashboard. The user does not have to figure out that charts are generated from a worksheet that is located in a workbook. The guided prompts tells the user what the necessary steps are. This saves the user time to execute the task at hand. In FIG. 7B, the user has only one prompt to select: namely, selection of a workbook (step 712a, which is highlighted). Note that the chart configuration 714 in properties 718 is blank at this stage, as the only active prompt available is selection of a workbook (step 712a). This selection is shown in properties 718, where the user will select a workbook from the dropdown menu 722.

FIG. 7C illustrates a graphical user interface 700 in relation to FIG. 7B. Here, the user has already attended to selecting a workbook (step 712a in FIG. 7B) and worksheet (step 712b in FIG. 7B). The remaining step is 712c—population of the chart. Note that unlike FIG. 7B, chart configuration 714 now lists a number of dropdown menus for properties of the chart that is to be created.

FIG. 7D illustrates a graphical user interface 700 in relation to FIG. 7C. Once the user has selected the step of populating the chart (step 712c in FIG. 7C), the resulting bar chart 716 appears, with the properties specified in chart configuration 714. In addition, a new set of prompts 724 appears, that provide the user an optional step of adding one or more columns to the chart. Once again, the user does not have to search or figure out what possible next steps are, for building the dashboard.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor; and
a memory storing instructions that, when executed by the processor, configure the system to:
select, by the processor, a resource based on a user selection of the resource on a graphical user interface;
set, by the processor, a context of the resource;
change, by the processor, the context to a new context, based on user interaction with the a graphical user interface;
notify, by the processor, one or more listeners of a context change;
notify, by the processor, an action planner of the context change;
process, by the processor, the new context;
compute, by the processor, one or more successive steps for the new context;
prioritize, by the processor, the one or more successive steps for the new context;
return, by the processor, a prioritized set of action commands;
broadcast, by the processor, the prioritized set of action commands to the one or more listeners; and
render, by the processor, the prioritized set of action commands to the user for selection.

2. The system of claim 1, wherein the instructions further configure the system to:
execute, by the processor, one or more action commands selected by the user.

3. The system of claim 1, wherein the resource is at least one of a workbook, a dashboard and a form.

4. The system of claim 1, wherein the graphical user interface comprises a canvas, the canvas comprising at least one of a visual modeler, a resource properties panel and a resource preview panel.

5. The system of claim 1, wherein when there is only one successive step, the instructions further configure the system to:
automatically execute, by the processor, the one successive step.

6. The system of claim 1, wherein when computing the one or more successive steps for the new context, the instructions further configure the system to:
load, by the processor, one or more specifications of the resource; and
use, by the processor, one or more pre-defined rules for computing the one more successive steps.

7. The system of claim 1, wherein when computing the one or more successive steps for the new context, the instructions further configure the system to:
execute, by the processor, a machine learning model.

8. A non-transitory computer-readable storage medium, the computer-readable storage medium including instructions that when executed by a computer, cause the computer to:
select, by a processor, a resource based on a user selection of the resource on a graphical user interface;
set, by the processor, a context of the resource;
change, by the processor, the context to a new context, based on user interaction with the a graphical user interface;
notify, by the processor, one or more listeners of a context change;
notify, by the processor, an action planner of the context change;
process, by the processor, the new context;
compute, by the processor, one or more successive steps for the new context;
prioritize, by the processor, the one or more successive steps for the new context;
return, by the processor, a prioritized set of action commands;
broadcast, by the processor, the prioritized set of action commands to the one or more listeners; and
render, by the processor, the prioritized set of action commands to the user for selection.

9. The non-transitory computer-readable storage medium of claim 8, wherein the instructions further configure the computer to:
execute, by the processor, one or more action commands selected by the user.

10. The non-transitory computer-readable storage medium of claim 8, wherein the resource is at least one of a workbook, a dashboard and a form.

11. The non-transitory computer-readable storage medium of claim 8, wherein the graphical user interface comprises a canvas, the canvas comprising at least one of a visual modeler, a resource properties panel and a resource preview panel.

12. The non-transitory computer-readable storage medium of claim 8, wherein when there is only one successive step, the instructions further configure the computer to:
automatically execute, by the processor, the one successive step.

13. The non-transitory computer-readable storage medium of claim 8, wherein when computing the one or more successive steps for the new context, the instructions further configure the computer to:
load, by the processor, one or more specifications of the resource; and
use, by the processor, one or more pre-defined rules for computing the one more successive steps.

14. The non-transitory computer-readable storage medium of claim 8, wherein when computing the one or more successive steps for the new context, the instructions further configure the computer to:
execute, by the processor, a machine learning model.

15. A computer-implemented method comprising:
selecting, by a processor, a resource based on a user selection of the resource on a graphical user interface;
setting, by the processor, a context of the resource;
changing, by the processor, the context to a new context, based on user interaction with the graphical user interface;
notifying, by the processor, one or more listeners of a context change;
notifying, by the processor, an action planner of the context change;
processing, by the processor, the new context;
computing, by the processor, one or more successive steps for the new context;
prioritizing, by the processor, the one or more successive steps for the new context;
returning, by the processor, a prioritized set of action commands;
broadcasting, by the processor, the prioritized set of action commands to the one or more listeners; and
rendering, by the processor, the prioritized set of action commands to the user for selection.

16. The computer-implemented method of claim 15, further comprising:
executing, by the processor, one or more action commands selected by the user.

17. The computer-implemented method of claim 15, wherein the resource is at least one of a workbook, a dashboard and a form.

18. The computer-implemented method of claim 15, wherein the graphical user interface comprises a canvas, the canvas comprising at least one of a visual modeler, a resource properties panel and a resource preview panel.

19. The computer-implemented method of claim 15, wherein when there is only one successive step, the method further comprises:
automatically executing, by the processor, the one successive step.

20. The computer-implemented method of claim 15, wherein computing the one or more successive steps for the new context comprises:
loading, by the processor, one or more specifications of the resource; and
using, by the processor, one or more pre-defined rules for computing the one more successive steps.

21. The computer-implemented method of claim 15, wherein computing the one or more successive steps for the new context comprises:
executing, by the processor, a machine learning model.
